(19) United States
(12) Patent Application Publication
(10) Pub. No.: US 2008/0266269 A1
(43) Pub. Date: Oct. 30, 2008

(54) PORTABLE TOUCH-TYPE KEYBOARD

(75) Inventors: Bong Woo Lee, Seoul (KR); Dong Jin Min, Seoul (KR); Jae Young Jo, Seoul (KR)

Correspondence Address: ROTHWELL, FIGG, ERNST & MANBECK, P.C., 1425 K STREET, N.W., SUITE 800, WASHINGTON, DC, 20005, US

(73) Assignee: MELFAS INC., Seoul (KR)

(21) Appl. No.: 11/859,365

(22) Filed: Sep. 21, 2007

(30) Foreign Application Priority Data
Apr. 27, 2007 (KR) 20-2007-0006999

(51) Int. Cl. G06F 3/041

(52) U.S. Cl. 345/173

(57) ABSTRACT

Disclosed herein is a portable touch-type keyboard in which touch type electrodes are included in a printed circuit board (PCB) and keys each having a pad shape are formed on a flat plate in correspondence with the touch type electrodes so as to transmit/receive a signal to/from an external device via wired/wireless communication such that key data indicating a character or a function can be input. The portable keyboard includes a pad key touch panel including a plurality of pad type touch electrodes contained in predetermined containing spaces of a printed circuit board (PCB) and pad keys formed on an upper plane in correspondence with the touch electrodes, and a signal operation module which processes signals received from the plurality of pad keys, generates a key signal, and transmits the key input signal to an external device via wired/wireless communication. Accordingly, it is possible to provide a keyboard which is used for typewriting, has a small total size due to the decrease of the size of keypads, and includes a plurality of keys arranged therein. It is possible to provide a portable keyboard which is capable of transmitting key input data to an external device via wired/wireless communication and being folded or wound when a flexible printed circuit board (FPCB) is employed.

### CROSS REFERENCE TO RELATED APPLICATIONS

This application claims priority from Korean utility model application No. 20-2007-0006999 filed on Apr. 27, 2007, all of which is incorporated herein by reference in its entirety for all purposes.

### BACKGROUND OF THE INVENTION

1. Field of the Invention

The present invention relates to a keyboard for inputting key data indicating a character or a function, and more particularly, to a portable touch-type keyboard in which touch type electrodes are included in a printed circuit board (PCB) and keys each having a pad shape are formed on a flat plate in correspondence with the touch type electrodes so as to transmit/receive a signal to/from an external device via wired/wireless communication such that the keyboard can be conveniently used.

2. Description of the Related Art

As a high precision technology such as an information technology (IT) and a nano technology has been developed, a device or an apparatus has been multi-functionalized or has become complicated. As lightness, thinness, and smallness of the device or the apparatus have been realized, the size of the device or the apparatus has been decreased. There is a need for a portable keyboard which can be conveniently used anywhere and anytime.

Due to such necessity, various types of portable keyboards have been developed. However, since a conventional keyboard has a large size and is made of a hard material, it is inconvenient to carry the conventional keyboard. In addition, since the conventional keyboard is divided into multi-parts such as two parts or three parts, it is difficult to manufacture the conventional keyboard.

Since a conventional folding or winding type keyboard has a large size, the size of the folded or wound keyboard is smaller than that of the unfolded or unwound keyboard, but the thickness of the folded or wound keyboard is large. Accordingly, it is inconvenient to carry the keyboard.

As data terminals each having a small size, such as a personal digital assistant (PDA), a mobile phone and a portable multimedia player (PMP), have been developed, a demand for a new type of portable keyboard which can be conveniently and efficiently used has been increased.

### SUMMARY OF THE INVENTION

Therefore, the present invention has been made in view of the above problems, and it is an object of the present invention to provide a keyboard which is used for typewriting, has a small total size due to the decrease of the size of keypads, and includes a plurality of keys arranged therein.

It is another object of the present invention to provide a portable keyboard which is capable of being folded or wound when a flexible printed circuit board (FPCB) is employed.

It is a further object of the present invention to provide a keyboard which includes several additional function keys as well as character keys of a general keyboard and includes keypads arranged on a flat plate such that the total size thereof is small enough for carrying the keyboard in a case where a flexible PCB made of a soft material is used and the keyboard is folded or wound.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a portable touch-type keyboard according to an embodiment of the present invention;

FIG. 2 is a front view showing the portable touch-type keyboard according to the embodiment of the present invention;

FIG. 3 is a cross-sectional view showing the portable touch-type keyboard according to the embodiment of the present invention; and

FIG. 4 is a block diagram showing an operation of the portable touch-type keyboard according to the embodiment of the present invention.

### DETAILED DESCRIPTION OF THE PREFERRED EMBODIMENTS

Hereinafter, a preferred embodiment of the present invention will be described in detail with reference to the accompanying drawings.

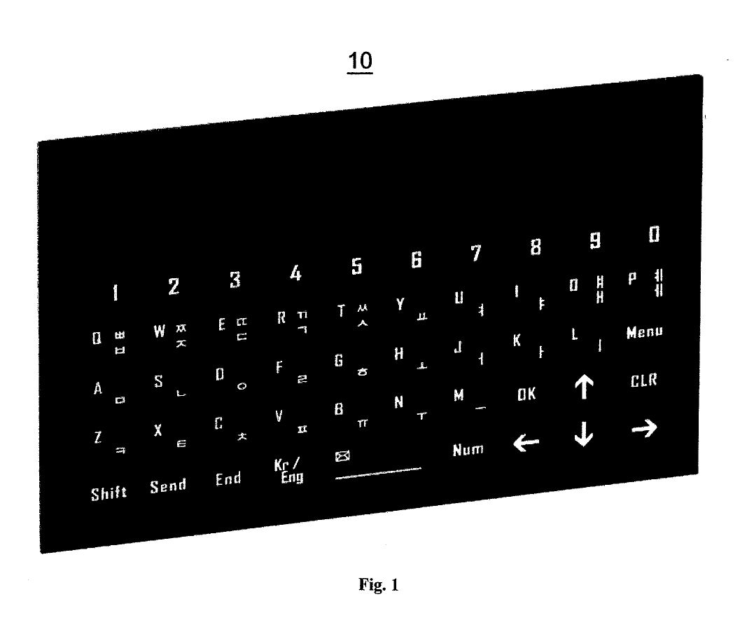

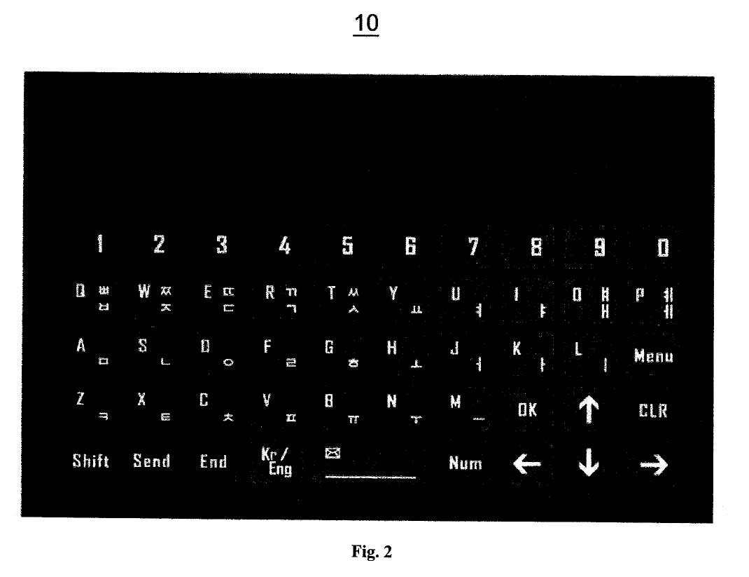

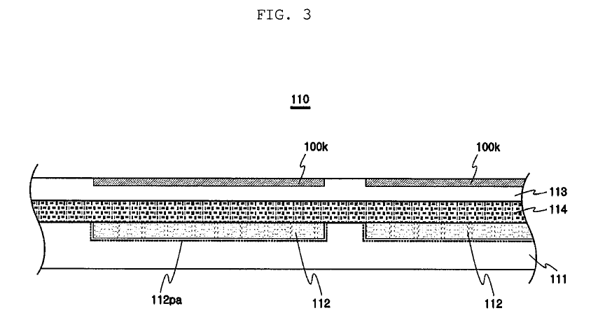

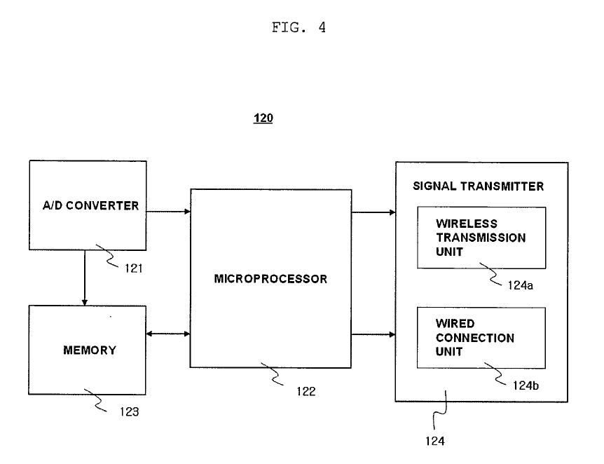

FIG. 1 is a perspective view showing a portable touch-type keyboard according to an embodiment of the present invention, FIG. 2 is a front view showing the portable touch-type keyboard according to the embodiment of the present invention, FIG. 3 is a cross-sectional view showing the portable touch-type keyboard according to the embodiment of the present invention, and FIG. 4 is a block diagram showing an operation of the portable touch-type keyboard according to the embodiment of the present invention.

In the present embodiment, a portable touch-type keyboard 10 which can be folded or wound by employing a flexible printed circuit board (FPCB) made of a soft material as a printed circuit board (PCB) will be described. Alternatively, a PCB made of a hard material may be used.

The portable touch-type keyboard 10 according to the embodiment of the present invention includes a pad key touch panel 110 and a signal operation module 120.

As shown, the portable touch-type keyboard 10 according to the present embodiment includes the pad key touch panel 110 in which a plurality of pad type touch electrodes 112 are positioned in predetermined containing spaces of the PCB and pad keys 100k are provided on an upper plane in correspondence with the pad type touch electrodes 112; and the signal operation module 120 for processing signals received from the plurality of pad keys 100k, generating a key signal, and transmitting key input data to an external device via wired/wireless communication.

In the portable touch-type keyboard 10, as shown in FIG. 3, the pad key touch panel 110 includes the PCB 111 having the plurality of predetermined containing spaces for containing the touch electrodes 112 arranged in the upper surface of the PCB in correspondence with the touch electrodes 112; the touch electrodes 112 which have a thin pad shape, are arranged in the upper surface of the PCB, receive a pressure applied from the top, and generate a signal indicating a pressing state; and a pad film 113 which is coated on the PCB including the touch electrodes 112 and includes predetermined key patterns displayed on a plane.

In the portable touch-type keyboard 10 according to the present embodiment, the PCB is preferably a portable PCB which is made of a soft material so as to be folded and wound or is a portable PCB made of a hard material.

In the portable touch-type keyboard 10, as shown in FIG. 4, the signal operation module 120 includes a microprocessor 122 which controls the elements of the signal operation module 120 and the operations thereof so as to output a signal to a device which requires the input of the keyboard 10; an A/D converter 121 which receives a signal from the touch electrodes 112 of the pad key touch panel 110 and converts the signal into a digital signal; a memory 123 which stores data generated by the processing of the microprocessor 122 and the A/D converter 121; and a signal transmitter 124 which is connected to an external device for receiving data from the keyboard 10 via wired/wireless communication so as to transmit the processed key input data.

In the portable touch-type keyboard 10, the touch electrodes 112 receive voltages indicating the pressing states of the pad keys 100k and output at least one channel signal for identifying the channel. The touch electrodes 112 output the voltages which vary according to variations in capacitance due to the pressing states of the pad keys 100k.

The elements of the pad key touch panel 110 according to the present embodiment will now be described in detail. The FPCB 111 is made of a soft material and can be folded or wound. The FPCB 111 made of the soft material includes predetermined electrode spaces 112pa which contain the touch electrodes 112 corresponding to the plurality of pad keys 100k provided at the upper side of the pad key touch panel 110.

The touch electrodes 112 have a thin pad or plate shape. Accordingly, if any one of the pad keys 100k is pressed, a signal indicating the pressing state of the key is generated, due to capacitance between a finger of the user and the touch electrode 112. The generated signal is sent to the A/D converter 121.

As shown in FIG. 2, the touch electrodes 112 according to the present embodiment are arranged in a plurality of rows and a predetermined pattern. The touch electrodes 112 receive a signal in a matrix so as to identify the signals received from the touch electrodes 112. In the present embodiment, the pressing states of the pad keys 100k are identified using two groups each having 16 channels in a matrix.

The mold pad film 113 is formed on the pad keys 100k so as to protect the outer surface of the keyboard 10. On the pad film 113, characters for displaying character keys or function keys are marked on a predetermined pattern (a rectangular pattern in the present embodiment) in correspondence with the touch electrodes 112, thereby forming the pad keys 100k.

In the keyboard 10, it is preferable that the FPCB 111 including the touch electrodes 112 and the mold pad film 113 are physically in contact with each other while maintaining the softness of the keyboard 10. In the present embodiment, a double sided tape 115 is coated on the FPCB 111 including the touch electrodes 112 so as to increase an adhesive force between the FPCB 111 and the mold pad film 113.

In the keyboard 10, since the touch electrodes 112 are provided in the predetermined containing spaces of the FPCB 111, the pad key touch panel 110 having the pad keys 100k is made flat, unlike a general keyboard 10 or a character input device.

Next, the signal operation module 120 according to the present embodiment which processes a key input signal received from the pad key touch panel 110 will be described in detail. The A/D converter 121 receives analog signals from the touch electrodes 112 of the pad key touch panel 110 and converts the analog signals into digital signals. Accordingly, the A/D converter 121 receives signals of two groups each having 16 channels, which are generated by pressing the pad keys 100k, from the touch electrodes 112 and converts the signals into the digital signals.

The digital signals output from the A/D converter 121 are input to the microprocessor 122. The microprocessor 122 processes the signals received from the A/D converter 121, outputs the key input signal in a standard format, and performs a function for controlling the elements of the signal operation module 120 and the operations thereof.

The digital signals converted by the A/D converter 121 are stored in the memory 123. The memory 123 stores a variety of data processed by the signal operation module 120. Accordingly, the variety of data is stored in and read from the memory 123 in the data processing operation by the microprocessor 122.

The microprocessor 122 controls the operations of the elements of the keyboard 10 and the operations thereof and executes a necessary command so as to output a signal to an external device which requires the input of the keyboard 10, such as a mobile phone or a PDA.

In the present embodiment, a constant voltage is applied to the touch electrodes 112 of the pad keys 100k. Accordingly, when a user presses any one of the pad keys 100k, the voltage applied to the corresponding pad key 100k is changed (the voltage is switched from a high level to a low level or from a low level to a high level) . The changed analog signal is converted into the digital signal by the A/D converter 121. The microprocessor 122 detects a variation in voltage, detects the pressed pad key 100k, and outputs code data corresponding to the corresponding pad key 100k. In addition, the microprocessor 122 outputs predetermined signals for the function keys as well as the character keys.

The signal transmitter 124 for transmitting the processed key input signal to the external device is located at the next stage of the microprocessor 122.

In the present embodiment, a wireless transmission unit 124a of the signal transmitter 124 wirelessly transmits a signal to the external device. In the present embodiment, the wireless transmission unit 124a is implemented by Bluetooth which is a local wireless networking communication technology and Zigbee which is a standard technology for a data network and home automation having a low transmission speed.

A wired connection unit 124b includes a connector for wired connection. In the present embodiment, the wired connection unit 124b includes a universal serial bus (USB) connector for universal serial communication and a RS-232C DTE connector for a universal asynchronous receiver/transmitter (UART) for asynchronous serial communication, such as a computer.

In order to allow a user to connect the keyboard 10 to the external device such as a PDA or a mobile phone, a program necessary for the external device needs to be installed in a connection using wireless communication. When the external device recognizes the keyboard 10, the data typewritten by the keyboard 10 is subjected to a necessary process and is then transmitted and input to the external device via the wireless transmission unit 124a.

Even in the connection using the USB connector or the RS232C DTE connector for the UART, the external device having a program installed therein may be connected to the connector and the keyboard 10 may be plugged into the connector using a plug and play function by wire.

In the keyboard 10 according to the present embodiment shown in FIG. 2, the pad keys 100k include the function keys which are widely used in a general mobile phone and the character keys for Korean characters or English characters. The arrangement shown in FIG. 2 is only exemplary and additional keys necessary for the external device may be further included.

Although, in the present embodiment, the portable touch-type keyboard 10 which can be folded or wound by employing a flexible printed circuit board (FPCB) made of a soft material as a printed circuit board (PCB) is described, a PCB made of a hard material may be also used. Since the size of each of the pad keys 100k of the keyboard is small, several additional pad keys 100k may be further included in addition to the pad keys 100k shown in FIG. 2. In this case, it is not difficult to carry the keyboard 10.

As described above, the keyboard 10 according to the present embodiment can be variously implemented on the basis of the technology of the present invention and the modified examples are included in the scope of the present invention.

As described above, it is possible to provide a keyboard which is used for typewriting, has a small total size due to the decrease of the sizes of keypads, and includes a plurality of keys arranged therein.

It is possible to provide a keyboard which includes several additional function keys as well as character keys of a general keyboard and includes keypads arranged on a flat plate such that the total size thereof is small enough for carrying the keyboard when the keyboard is folded or wound, unlike a conventional keyboard.

It is possible to provide a portable keyboard which is capable of transmitting key input data to an external device via wired/wireless communication and being folded or wound when a flexible printed circuit board (FPCB) is employed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A portable touch-type keyboard comprising:
a pad key touch panel including a plurality of pad type touch electrodes contained in predetermined containing spaces of a printed circuit board (PCB) and pad keys formed on an upper plane in correspondence with the touch electrodes; and
a signal operation module which processes signals received from the plurality of pad keys, generates a key signal, and transmits the key input signal to an external device via wired/wireless communication.

2. The portable touch-type keyboard according to claim 1, wherein the pad key touch panel includes:
the PCB in which the plurality of predetermined containing spaces for containing the touch electrodes are formed in a predetermined array in correspondence with the touch electrodes;
the touch electrodes which have a thin pad shape, are contained in the upper surface of the PCB, receive pressure applied from the top, and generate signals indicating pressing states; and
a pad film which is coated on the PCB including the touch electrodes and is provided with predetermined key patterns formed thereon.

3. The portable touch-type keyboard according to claim 1, wherein the PCB is made of a soft material which can be folded or wound or a hard material.

4. The portable touch-type keyboard according to claim 1, wherein the touch electrodes receive voltages for identifying pressing states of the pad keys and output at least one channel signal for identifying a channel.

5. The portable touch-type keyboard according to claim 1, wherein the touch electrodes output voltages which are changed by variations in capacitance due to the pressing states of the pad keys.

6. The portable touch-type keyboard according to claim 1, wherein the signal operation module includes:
an A/D converter which receives the signals from the touch electrodes of the pad key touch panel and converts the signals into digital signals;
a microprocessor which controls the elements of the signal operation module and the operations thereof so as to process the signals received from the A/D converter, output a key input signal to the external device which requires the input of the keyboard;
a memory which stores data generated by the processing of the microprocessor and the A/D converter; and
a signal transmitter which is connected to the external device for receiving data from the keyboard via wired/wireless communication so as to transmit the processed key input signal.

7. The portable touch-type keyboard according to claim 2, wherein the PCB is made of a soft material which can be folded or wound or a hard material.
